(19) United States
(12) Patent Application Publication
(10) Pub. No.: US 2014/0236737 A1
(43) Pub. Date: Aug. 21, 2014

(54) WEARABLE COMPUTERS AS MEDIA EXPOSURE METERS

(71) Applicant: GOOGLE INC., Mountain View, CA (US)

(72) Inventor: Simon Michael Rowe, Finchampstead (GB)

(73) Assignee: GOOGLE INC., Mountain View, CA (US)

(21) Appl. No.: 14/351,498

(22) PCT Filed: Oct. 12, 2012
(86) PCT No.: PCT/US2012/060092

§ 371 Date: Apr. 11, 2014

Related U.S. Application Data
(60) Provisional application No. 61/547,542, filed on Oct. 14, 2011.

(51) Int. Cl. G06Q 30/02

(52) U.S. Cl. CPC G06Q 30/0272
USPC 705/14.68

(57) ABSTRACT

Based on the type of media consumed and when it is accessed, it is possible to identify times during which a particular user will likely be more receptive to particular types of related content. Aspects of the present disclosure, describe implementations that are configured to monitor media exposure and consumption of particular individuals using, for example, client device such as a smart phone, a tablet computer, or the like utilized primarily by one respective user. In some implementations, related content is then provided to a particular user when that user is more likely to be responsive to the related content based on media exposure and consumption patterns derived from usage patterns of the respective client device

### TECHNICAL FIELD

The disclosed implementations relate generally to systems, methods and devices configured to monitor information about media exposure and provide related content.

### BACKGROUND

People are regularly exposed to advertising throughout the day through various forms of media, including print, television, radio and the Internet. However, advertising tends to be broadcast to a wide audience, rather than individually tailored to what a particular user may be currently responsive to. For example, a billboard or poster in a subway station will be viewed by a diverse urban audience, but may only advertise a product or service that a small portion of the audience may be interested in. As a result, the billboard or poster will be ignored by most of the people that see it. The same may be true for magazine advertisements, radio spots and television commercials.

In order words, advertising can be inefficient. But it is difficult for advertisers to specifically target the interests of particular users because advertisers have thus far not been able to collect detailed information about particular users with respect to how those users access and consume media. For example, it is difficult for an advertiser to determine if a particular consumer is currently looking to purchase a particular good (e.g. a car) or service (e.g. dine at a restaurant), and send that consumer relevant information or advertisements at a time when that particular user may be most receptive to the information or advertisement.

### SUMMARY

The aforementioned deficiencies and other problems are reduced or eliminated by the disclosed systems, methods and devices. Various implementations of systems, methods and devices within the scope of the claims each have several aspects, no single one of which is solely responsible for the desirable attributes described herein. Without limiting the scope of the claims, some prominent features of example implementations are described herein. After considering this description one will understand how the features of various implementations are configured to enable various systems, methods and devices to monitor information about how and when a particular user is exposed to various forms of media, and provide related content at times that the user may be more responsive to the related content.

More specifically, in some implementations, the systems, methods and devices described herein enable advertisers and/or media measurement companies to determine when a particular user is exposed to or consumes various forms of media, and in turn, determine when that user is likely to most receptive to receiving related content. A typical person is exposed to media and advertising throughout the day. For example, during a typical workday, a person may watch the morning news on television during breakfast, listen to the radio while driving to work, browse various websites while at work, and watch primetime television or streaming videos over the internet after work. On a weekend, that same person may alter their media exposure and consumption patterns. For example, that person may not, for example, access a website that is routinely accessed during the workday for work purposes, and instead access different websites based on personal interests, hobbies and/or for online shopping.

Based on the type of media consumed and when it is accessed, it is possible to identify times during which a particular user will likely be more receptive to particular types of related content. Aspects of the present disclosure, describe implementations that are configured to monitor media exposure and consumption of particular individuals using, for example, client device such as a smart phone, a tablet computer, or the like utilized primarily by one respective user. In some implementations, related content is then provided to a particular user when that user is more likely to be responsive to the related content based on media exposure and consumption patterns derived from usage patterns of the respective client device.

### BRIEF DESCRIPTION OF THE DRAWINGS

So that the manner in which features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other effective aspects.

FIG. 1 is a block diagram of a client-server environment according to some implementations.

FIG. 2A is a block diagram of a client-server environment according to some implementations.

FIG. 2B is a block diagram of a client-server environment according to some implementations.

FIG. 3A is a block diagram of a configuration of a server system according to some implementations.

FIG. 3B is a block diagram of a data structure according to some implementations.

FIG. 4A is a block diagram of a configuration of a client device according to some implementations.

FIG. 4B is a block diagram of a configuration of another client device according to some implementations.

FIG. 5 is a flowchart representation of a method according to some implementations.

FIG. 6 is a flowchart representation of a method according to some implementations

FIG. 7 is a flowchart representation of a method according to some implementations.

FIG. 8 is a signaling diagram representation of some of the transmissions between devices according to some implementations.

In accordance with common practice the various features illustrated in the drawings may not be drawn to scale. As such, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Reference will now be made in detail to various implementations, examples of which are illustrated in the accompanying drawings. In the following detailed description, numerous specific details are set forth in order to provide a thorough understanding of aspects of the implementations. However, the invention may be practiced without these specific details. In other instances, well-known methods, procedures, components, and circuits have not been described in detail so as not to unnecessarily obscure aspects of the disclosed implementations.

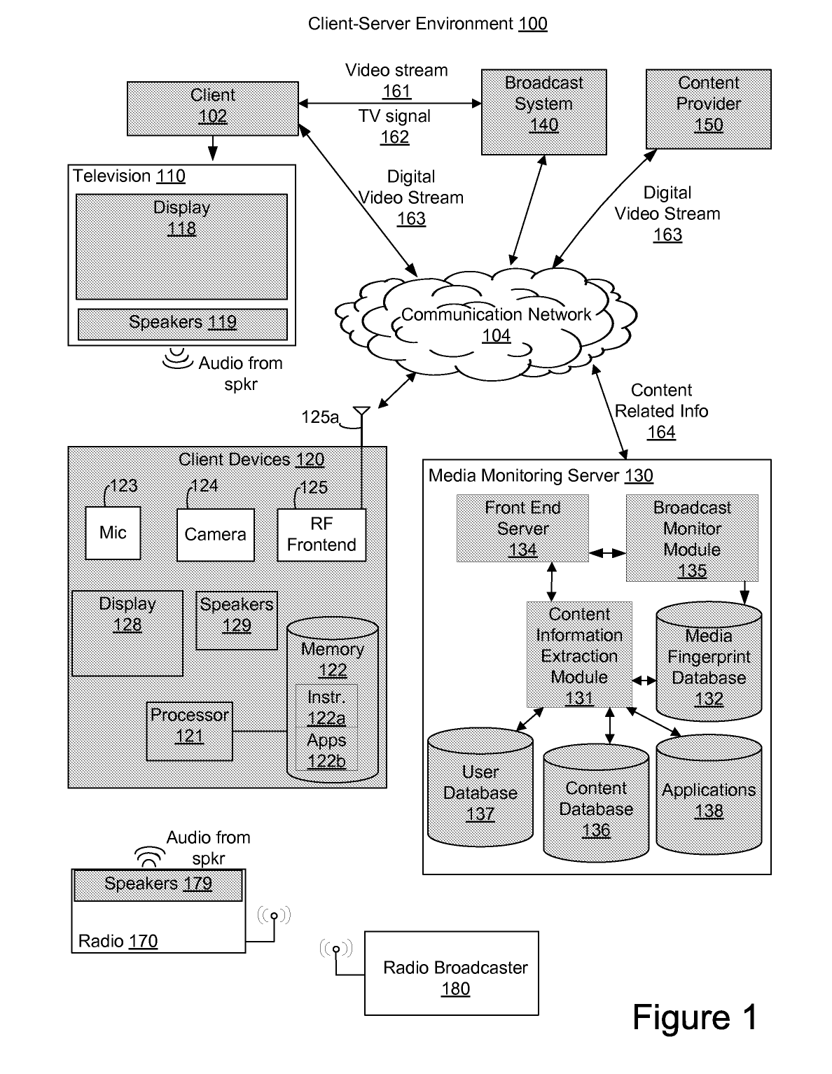

FIG. 1 is a block diagram of a simplified example client-server environment 100 according to some implementations. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes a client device 102, a television (TV) 110, one or more client devices 120, a communication network 104, a media monitoring server 130, a broadcast system 140, a content provider 150, a radio broadcaster 180 and a radio 170. The client device 102, the one or more client devices 120, the media monitoring server 130, the broadcast system 140, the content provider 150, the radio broadcaster 180 and the radio 170 are capable of being connected to the communication network 104 in order to exchange information with one another and/or other devices and systems.

In some implementations, the media monitoring server 130 is implemented as a single server system, while in other implementations it is implemented as a distributed system of multiple servers. Solely for convenience of explanation, the media monitoring server 130 is described below as being implemented on a single server system. Similarly, in some implementations, the broadcast system 140 is implemented as a single server system, while in other implementations it is implemented as a distributed system of multiple servers. Solely, for convenience of explanation, the broadcast system 140 is described below as being implemented on a single server system. Similarly, in some implementations, the content provider 150 is implemented as a single server system, while in other implementations it is implemented as a distributed system of multiple servers. Solely, for convenience of explanation, the content provider 150 is described below as being implemented on a single server system. Moreover, the functionality of the broadcast system 140 and the content provider 150 can be combined into a single server system. Additionally and/or alternatively, while only one broadcast system and only one content provider is illustrated in FIG. 1 for the sake of brevity, those skilled in the art will appreciate from the present disclosure that fewer or more of each may be present in an implementation of a client-server environment.

The communication network 104 may be any combination of wired and wireless local area network (LAN) and/or wide area network (WAN), such as an intranet, an extranet, including a portion of the Internet. It is sufficient that the communication network 104 provides communication capability between the one or more client devices 120 and the media monitoring server 130. In some implementations, the communication network 104 uses the HyperText Transport Protocol (HTTP) to transport information using the Transmission Control Protocol/Internet Protocol (TCP/IP). HTTP permits client devices 102 and 120 to access various resources available via the communication network 104. However, the various implementations described herein are not limited to the use of any particular protocol.

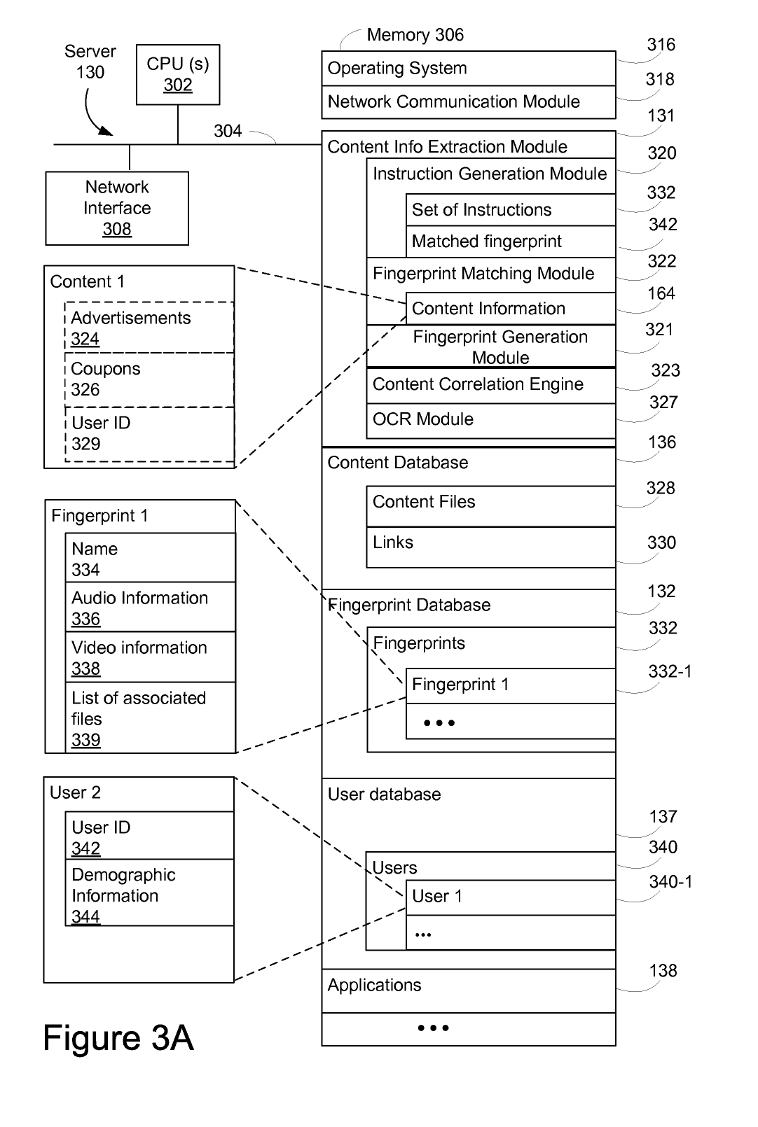

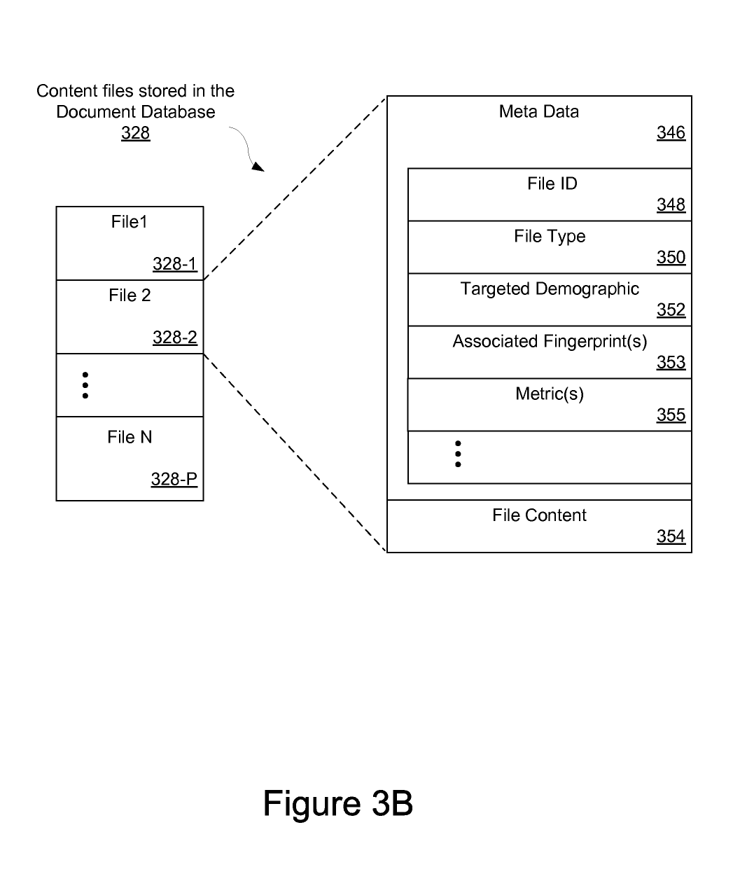

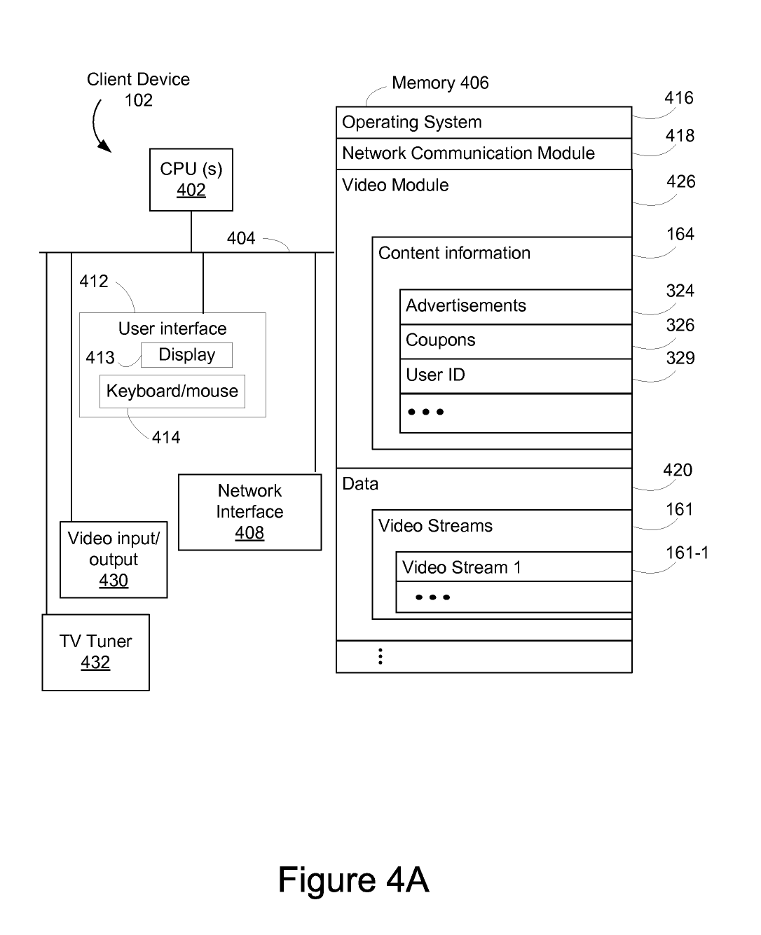

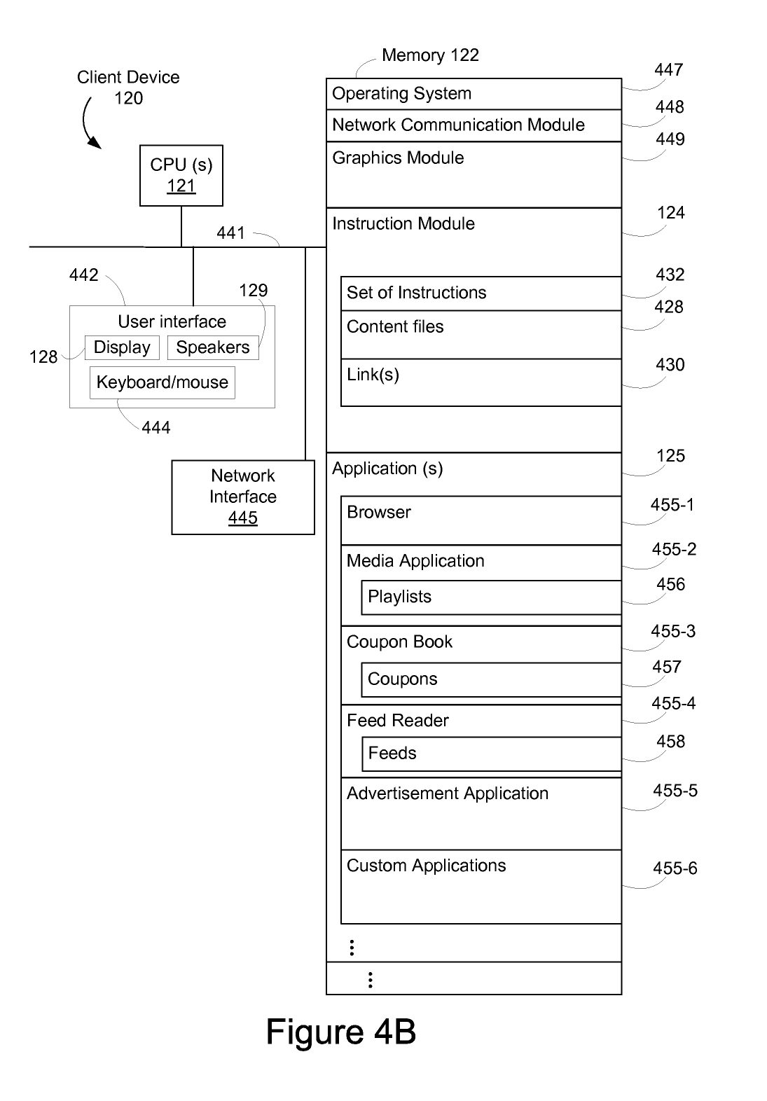

In some implementations, the media monitoring server 130 includes a front end server 134 that facilitates communication between the media monitoring server 130 and the communication network 104. The front end server 134 receives content information 164 from the one or more client devices 120. As described in greater detail below with reference to FIGS. 3A-4B, in some implementations, the content information 164 is a video stream, a portion thereof, and/or a reference to a portion thereof. A reference to a portion of a video stream may include a time indicator and/or a digital marker referencing the content of the video stream. In some implementations, the content information 164 is derived from a video stream being presented (i.e. playing) by the combination of the TV 110 and the client 102.

In some implementations, the front end server 134 is configured to send a set of instructions to the one or more client devices 120. In some implementations, the front end server 134 is configured to send content files and/or links to content files. The term “content file” includes any document or content of any format including, but not limited to, a video file, an image file, a music file, a web page, an email message, an SMS message, a content feed, an advertisement, a coupon, a playlist, an XML document and/or location information. In some implementations, the front end server 134 is configured to send or receive one or more video streams. In some implementations, the front end server 134 is configured to receive content directly from the broadcast system 140 and/or the content provider 150 over the communication network 104.

According to some implementations, a video or video stream is a sequence of images or frames representing scenes in motion. A video can be distinguished from an image. A video displays a number of images or frames per second. For example, a video displays 20 to 60 consecutive image frames per second. In more common implementations, video is defined using 24 or 25 frames per second. By contrast, an image is not necessarily associated with any other images.

A content feed (or channel) is a resource or service that provides a list of content items that are present, recently added, or recently updated at a feed source. A content item in a content feed may include the content associated with the item itself (the actual content that the content item specifies), a title (sometimes called a headline), and/or a description of the content, a network location or locator (e.g., URL) of the content, or any combination thereof. For example, if the content item identifies a text article, the content item may include the article itself inline, along with the title (or headline), and locator. Alternatively, a content item may include the title, description and locator, but not the article content. Thus, some content items may include the content associated with those items, while others contain links to the associated content but not the full content of the items. A content item may also include additional meta data that provides additional information about the content. For example, the meta data may include a time-stamp or embedded selectable website links. The full version of the content may be any machine-readable data, including but not limited to web pages, images, digital audio, digital video, Portable Document Format (PDF) documents, and so forth.

In some implementations, a content feed is specified using a content syndication format, such as RSS. RSS is an acronym that stands for “rich site summary,” “RDF site summary,” or “Really Simple Syndication.” “RSS” may refer to any of a family of formats based on the Extensible Markup Language (XML) for specifying a content feed and content items included in the feed. In some other implementations, other content syndication formats, such as the Atom syndication format or the VCALENDAR calendar format, may be used to specify content feeds.

In some implementations, the media monitoring server 130 is configured to receive content information 164 in the form of one or more media exposure reports from each client device 120, which possibly includes information that enables the media monitoring server 130 to determine the location of the client device when each of the one or more media exposure reports was generated. Upon receiving the content information, the media monitoring server 130 matches the content information to a content fingerprint in the fingerprint database 132. The media monitoring server 130 also determines the location of the client device 120 when the content information was generated, and in some cases also determines the type of location. For example, in some implementations, the media monitoring server 130 determines whether the content information received from the client device 120 was created in a residential location, in a retail location, a business location, etc.

The media monitoring server 130, based on the matched fingerprint and location information, identifies patterns associated with the usage of one ore more client devices 120 and exposure to the various forms and content of media sources as user exposed to. In turn, the media monitoring server 130 retrieves correlated content that can be push to the one or more client devices 120 at various times. In some implementations, the content is chosen based on speculation as to when and what a user will be particularly receptive to based on the indentified patterns.

For example, in one implementation, a smart phone is used to determine which radio station (or radio stations) a user listens to while driving to work. Advertisements delivered to the smart phone would likely be ignored while the user is driving. As such, based on the patterns of usage, related advertisements are pushed to the smart phone when the smart phone is believed to be stationary for extended periods, which may correspond to times when the user has time to consider the advertisements. Moreover, the type of advertisements delivered may be adjusted based on viewing habits during the day. For example, based on the browsing history of a particular user, a user may be more receptive to advertisements for new sports apparel during a mid-day break when the user is exercising or taking a break.

To that end, as described in greater detail below, in some implementations the media monitoring server 130 includes a content information extraction module 131 that is configured to to identify (i.e. fingerprint) the playing media content and provide information about the playing media content. In some implementations, the content information extraction module 131 is a distributed network of elements.

In some implementations, the media monitoring server 130 includes a user database 137 that stores user data. In some implementations, the user database 137 is a distributed database. In some implementations, the media monitoring server 130 includes a content database 136. In some implementations, the content database 136 includes advertisements, videos, images, music, web pages, email messages, SMS messages, content feeds, advertisements, coupons, playlists, XML documents, and ratings associated with various media content or any combination thereof. In some implementations, the content database 136 includes links to advertisements, videos, images, music, web pages, email messages, SMS messages, content feeds, advertisements, coupons, playlists, XML documents and ratings associated with various media content. In some implementations, the content database 136 is a distributed database.

As noted above, in some implementations, the media monitoring server 130 includes a fingerprint database 132 that stores content fingerprints. A content fingerprint includes any type of condensed or compact representation, or signature, of the content of a video stream and/or audio stream. In some implementations, a fingerprint may represent a clip (such as several seconds, minutes, or hours) of a video stream or audio stream. Or, a fingerprint may represent a single instant of a video stream or audio stream (e.g., a fingerprint of single frame of a video or of the audio associated with that frame of video). Furthermore, since video content may changes over time, corresponding fingerprints of that video content may also change over time. In some implementations, the fingerprint database 132 is a distributed database.

In some implementations, the rating server system 130 includes a broadcast monitor module 135 that is configured to create fingerprints of media content broadcast by the broadcast system 140 and/or the content provider 150.

In some implementations, the client device 102 is provided in combination with a display device such as a TV 110. The client device 102 is configured to receive a video stream 161 from the broadcast system 140 and pass the video stream to the TV 110 for display. While a TV has been used in the illustrated example, those skilled in the art will appreciate from the present disclosure that any number of displays devices, including computers, laptop computers, tablet computers, smart-phones and the like, can be used to display a video stream. Additionally and/or alternatively, the functions of the client 102 and the TV 110 may be combined into a single device.

In some implementations, the client device 102 is any suitable computer device capable of connecting to the communication network 104, receiving video streams, extracting information from video streams and presenting video streams for the display using the TV 110 (or another display device). In some implementations, the client device 102 is a set top box that includes components to receive and present video streams. For example, the client device 102 can be a set top box for receiving cable TV and/or satellite TV, a digital video recorder (DVR), a digital media receiver, a TV tuner, a computer, and/or any other device that outputs TV signals. In some implementations, the client device 102 displays a video stream on the TV 110. In some implementations the TV 110 can be a conventional TV display that is not connectable to the Internet and that displays digital and/or analog TV content received via over the air broadcasts or a satellite or cable connection.

As is typical of televisions, the TV 110 includes a display 118 and speakers 119. Additionally and/or alternatively, the TV 110 can be replaced with another type of display device 108 for presenting video content to a user. For example, the display device may be a computer monitor that is configured to receive and display audio and video signals or other digital content from the client 102. In some implementations, the display device is an electronic device with a central processing unit, memory and a display that is configured to receive and display audio and video signals or other digital content form the client 102. For example, the display device can be a LCD screen, a tablet device, a mobile telephone, a projector, or other type of video display system. The display device can be coupled to the client 102 via a wireless or wired connection.

In some implementations, the client device 102 receives video streams 161 via a TV signal 162. As used herein, a TV signal is an electrical, optical, or other type of data transmitting medium that includes audio and/or video components corresponding to a TV channel. In some implementations, the TV signal 162 is a terrestrial over-the-air TV broadcast signal or a sign distributed/broadcast on a cable-system or a satellite system. In some implementations, the TV signal 162 is transmitted as data over a network connection. For example, the client device 102 can receive video streams from an Internet connection. Audio and video components of a TV signal are sometimes referred to herein as audio signals and video signals. In some implementations, a TV signal corresponds to a TV channel that is being displayed on the TV 110.

In some implementations, a TV signal 162 carries information for audible sound corresponding to an audio track on a TV channel. In some implementations, the audible sound is produced by the speakers 119 included with the TV 110.

In some implementations, the radio broadcaster 180 provides radio transmissions. In various implementations the radio transmissions may include for example, satellite radio transmissions, internet radio transmissions, AM radio transmissions and/or FM radio transmissions. The radio 170 is configured to receive the radio transmissions and provide a corresponding audio output as would be known to those skilled in the art. To that end, the radio 170 includes speakers 179 configured to provide the audio output from the radio 170.

Each client device 120 may be any suitable computer device that is capable of connecting to the communication network 104, such as a computer, a laptop computer, a tablet device, a netbook, an internet kiosk, a personal digital assistant, a mobile phone, a smart phone, a gaming device, or any other device that is capable of communicating with the media monitoring server 130. In some implementations, each client device 120 includes one or more processors 121, non-volatile memory 122 such as a hard disk drive, a display 128, speakers 129, and a microphone 123. Each client device 120 may also have input devices such as a keyboard, a mouse and/or track-pad (not shown). In some implementations, the client device 120 includes a touch screen display, a digital camera and/or any number of supplemental devices to add functionality.

In some implementations, each client device 120 is connected to and/or includes a display device 128. The display device 128 can be any display for presenting video content to a user. In some implementations, the display device 128 is the display of a television, or a computer monitor, that is configured to receive and display audio and video signals or other digital content from the client device 120. In some implementations, the display device 128 is an electronic device with a central processing unit 121, memory 122 and a display that is configured to receive and display audio and video signals or other digital content. In some implementations, the display device 128 is a LCD screen, a tablet device, a mobile telephone, a projector, or any other type of video display system. In some implementations, the client device 120 is connected to and/or integrated with the display device 128. In some implementations, the display device 128 includes, or is otherwise connected to, speakers capable of producing an audible stream corresponding to the audio component of a TV signal or video stream.

In some implementations, each client device 120 is connectable to the client device 102 via a wireless or wired connection 103. In some implementations where such connection exists, the client device 120 may optionally operate in accordance with instructions, information and/or digital content provided by the client device 102. In some implementations, the client device 102 issues instructions to the client device 120 that cause the client device 120 to present on the display 128 and/or the speaker 129 digital content that is complementary, or related to, digital content that is being presented by the client 102 on the TV 110.

In some implementations, the client device 120 includes a microphone 123 that enables the client device to receive sound (audio content) from, for example, the speakers 119 of the TV 110 or the speakers 179 of the radio 170. The microphone 123 enables the client device 120 to store the audio content/soundtrack that is associated with the video content as it is presented. The client device 120 can store this information locally and then send to the media monitoring server 130 content information 164 that is any one or more of: fingerprints of the stored audio content, the audio content itself, portions/snippets of the audio content, fingerprints of the portions of the audio content or references to the playing content.

In this way, the media monitoring server 130 can identify the content playing on the television or radio even if the electronic device on which the content is being presented is not an Internet-enabled device, such as an older TV set; is not connected to the Internet (temporarily or permanently) so is unable to send the content information 164; or does not have the capability to record or fingerprint media information related to the video content. Such an arrangement (i.e., where the client device 120 stores and sends the content information 164 to the media monitoring server 130) allows a user to receive from the media monitoring server 130 content triggered in response to the content information 164 no matter where the user is watching TV or listening to on the radio.

In some implementations, the client device 120 includes a camera 124 that enables the client device to record images or video from, for example, the display 118 of the TV 110 or a computer display, or from printed media, including newspapers, books, magazines, posters and billboards. The camera 124 enables the client device 120 to store images or video associated with various media sources that a user encounters through the day. The client device 120 can store this information locally and then send it to the media monitoring server 130 at preset times, periodically or as it is acquired, based on the preferences of a user or network operator.

In some implementations, the client device 120 includes a radio frequency (RF) frontend 125. The RF frontend 125 includes an antenna 125a, which allows the client device 120 to wirelessly access a communication network, such as a WiFi network or cellular network.

In some implementations, the client device 120 includes one or more applications 122b and/or sets of instructions 122b stored in the memory 122. As discussed in greater detail below, the processor 121 executes the one or more applications in accordance with a set of instructions received from the media monitoring server 130.

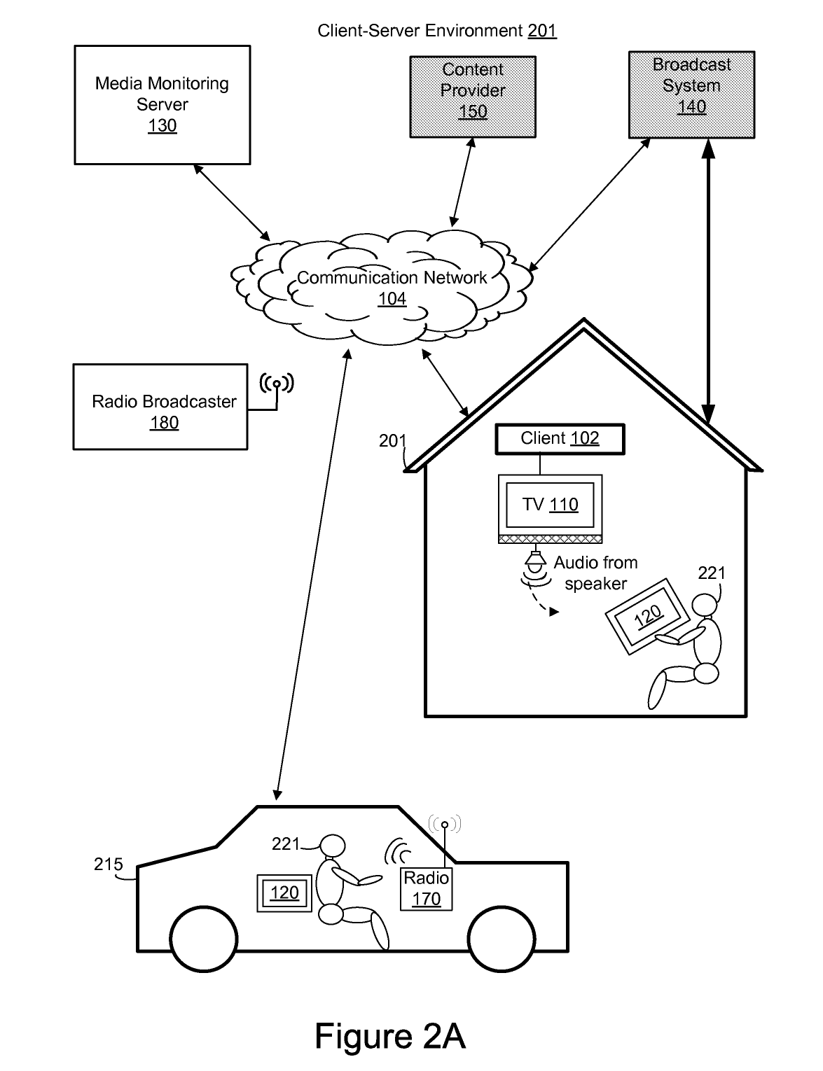

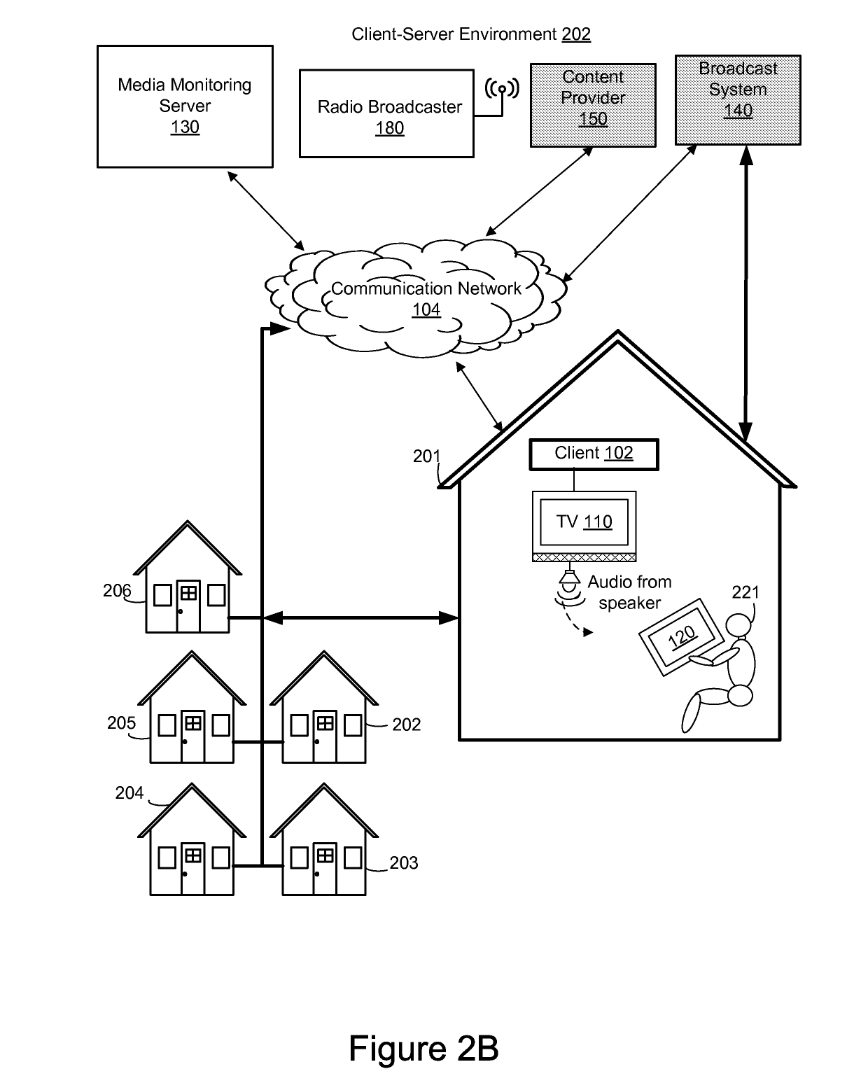

FIG. 2A is a block diagram of a client-server environment 201 according to some implementations. The client-server environment 201 illustrated in FIG. 2A is similar to and adapted from the client-server environment 100 illustrated in FIG. 1. Elements common to both share common reference indicia, and only the differences between the client-server environments 100, 201 are described herein for the sake of brevity.

As a non-limiting example, within the client-server environment 201, the client 102, the TV 110 and client device 120 are present together in a first residential location 201 during one portion of the day, and the radio 170 and client device are present together in a vehicle 205 during another portion of the day. In operation, the client device 102 receives a TV signal or some other type of streaming video signal or audio signal. The client device 102 then communicates at least a portion of the received signal to the TV 110 for display to the user 221. As described above, the client device 120 is configured to detect the media content playing on the TV 110 and report content associated with the media content playing on the TV 110 to the media monitoring server 130. Similarly, in the vehicle 205, the client device 120 is configured to detect the media content playing on the radio 170 and report content associated with the media content playing on the radio 170 to the media monitoring server 130. Moreover, while a residential location and a vehicle have been used in this particular example, those skilled in the art will appreciate from the present disclosure that client devices and the like can be located in any type of location, including commercial, residential, public and transportation locations. More specific details pertaining to how media exposure measurements are recorded and processed are described below with reference to the remaining drawings and continued reference to FIGS. 1, 2A and 2B.

FIG. 2B is a block diagram of a client-server environment 202 according to some implementations. The client-server environment 202 illustrated in FIG. 2B is similar to and adapted from the client-server environment 201 illustrated in FIG. 2A. Elements common to both share common reference indicia, and only the differences between the client-server environments 201, 202 are described herein for the sake of brevity.

As a non-limiting example, within the client-server environment 202, the client device 120 is included in a first residential location 201, as described above. In operation, the client device 102 uploads media exposure measurements to the media monitoring server 130. In turn, the media monitoring server 130 operates to identify access and exposure patterns associated with the use of the client device 102 based on the media exposure measurements provided by the client device 102. The media monitoring server 130 links the patterns to demographic information associated with user 221, and identifies other users and/or residences with similar and/or overlapping demographic information. For example, users with similar and/or overlapping demographic information may reside at residential locations 202, 203, 204, 205 and 206. While residential locations have been used in this particular example, those skilled in the art will appreciate from the present disclosure that client devices and the like can be located in any type of location, including commercial, residential and public locations. Further, the media monitoring server 130, having identified residential locations 202, 203, 204, 205 and 206 with similar demographics to user 221, pushes correlated content at various times based on the identified patterns based on media exposure measurements provided by client device 120. In other words, the client device 120 serves as a proxy for the user 221 and the user 221 servers as a representative member of a group of users with similar and/or overlapping demographic information. For example, if based on the media exposure measurements, it is determined that a particular user regularly searches for restaurants during particular days of the week before what is customarily dinner time, advertisements or coupons for local restaurants may be pushed to the client devices of all users that share similar and/or overlapping demographic information with user 221.

FIG. 3A is a block diagram of a configuration of the media monitoring server 130 according to some implementations. In some implementations, the media monitoring server 130 includes one or more processing units (CPU's) 302, one or more network or other communications interfaces 308, memory 306, and one or more communication buses 304 for interconnecting these and various other components. The communication buses 304 optionally include circuitry (sometimes called a chipset) that interconnects and controls communications between system components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, including the non-volatile and volatile memory device(s) within memory 306, comprises a non-transitory computer readable storage medium. In some implementations, memory 306 or the non-transitory computer readable storage medium of memory 306 stores the following programs, modules and data structures, or a subset thereof including an operation system 316, a network communication module 318, a content information extract module 131, a content database 136, a fingerprint database 132, a user database 137, and applications 138.

The operating system 316 includes procedures for handling various basic system services and for performing hardware dependent tasks.

The network communication module 318 facilitates communication with other devices via the one or more communication network interfaces 308 (wired or wireless) and one or more communication networks, such as the Internet, other wide area networks, local area networks, metropolitan area networks, and so on. With further reference to FIG. 1, the network communication module 318 may be incorporated into the front end server 134.

The content database 136 includes content files 328 and/or links to content files 230. In some implementations, the content database 136 stores advertisements, videos, images, music, web pages, email messages, SMS messages, a content feeds, advertisements, coupons, playlists, XML documents and any combination thereof. In some implementations, the content database 1376 includes links to advertisements, videos, images, music, web pages, email messages, SMS messages, content feeds, advertisements, coupons, playlists, XML documents and any combination thereof. Content files 328 are discussed in more detail in the discussion of FIG. 3B.

The user database 137 includes user data 340 for one or more users. In some implementations, the user data for a respective user 340-1 includes a user identifier 342 and demographic information 344. The user identifier 342 identifies a user. For example, the user identifier 342 can be an IP address associated with a client device 102 or an alphanumeric value chosen by the user or assigned by the server that uniquely identifies the user. The demographic information 244 includes the characteristics of the respective user. The demographic information may include may be one or more of the group consisting of age, gender, income, geographic location, education, wealth, religion, race, ethic group, marital status, household size, employment status, and political party affiliation.

The fingerprint database 132 stores one or more content fingerprints 332. A fingerprint 332 includes a name 334, fingerprint audio information 336 and/or fingerprint video information 338, and a list of associated files 339. The name 334 identifies the respective content fingerprint 332. For example, the name 334 could include the name of an associated television program, movie, or advertisement. In some implementations, the fingerprint audio information 336 includes a fingerprint or other compressed representation of a clip (such as several seconds, minutes, or hours) of the audio content of a video stream or an audio stream. In some implementations, the fingerprint video information 338 includes a fingerprint of a clip (such as several seconds, minutes, or hours) of a video stream. Fingerprints 332 in the fingerprint database 132 are periodically updated.

The content information extraction module 131 receives content information 164 from the client device 120, generates a set of instructions 132 and sends a set of instructions 132 to the client device 120. Additionally and/or alternatively, the media monitoring server 130 can receive content information 164 from the client device 102. The content information extraction module 131 includes an instruction generation module 320, a fingerprint matching module 322, a content correlation engine 323, and an optical character recognition (OCR) and code recognition module 327. In some implementations, the content information extraction module 131 also includes a fingerprint generation module 321, which generates fingerprints from the content information 164 or other media content saved by the server 130.

In some implementations, the content correlation engine 323 content correlated with information extracted from media exposure measurements. In some implementations, the OCR and code recognition module 327 is configured to apply an optical character recognition technique to the image of the receipt to determine what was purchased and create a corresponding record that can be used to identify correlated content, goods/and/or services. In some implementations, the OCR and code recognition module 327 is also configured identify barcodes, quick response (QR) codes, logos or covers so that the media monitoring server 130 can be used to identify magazines, books, catalogues or the like.

The fingerprint matching module 322 matches at least a portion of the content information 164 (or a fingerprint of the content information 164 generated by the fingerprint generation module) to a fingerprint 332 in the fingerprint database 132. The matched fingerprint 342 is sent to the instruction generation module 320. The fingerprint matching module 322 includes content information 164 received from at least one of the client device 102 and the client device 120 120. The content information 164 includes advertisements 324, coupons 326 and a user identifier 329. The user identifier 329 identifiers a user associated with at least one of the client device 102 and the client device 120 120. For example, the user identifier 329 can be an IP address associated with a client device 102 (or 120) or an alphanumeric value chosen by the user or assigned by the server that uniquely identifies the user. In some implementations, the advertisements 324 include advertisements related to goods and/or services associated with the media content the user is exposed to, based on the media exposure measurements. In some implementations, the coupons 326 include discounts related to goods and/or services associated with the media content the user is exposed to, based on the media exposure measurements.

The instruction generation module 320 generates a set of instructions 332 based on the matched fingerprint 342. In some implementations, the instruction generation module 320 generates the set of instructions 332 based on information associated with the matched fingerprint 342 and the user data 340 corresponding to the user identifier 329. In some implementations, the instruction generation module 320 determines one or more applications 138 associated with the matched fingerprint 342 to send to the client device 120. In some implementations, the instruction generation module 320 determines one or more content files 328 based on the matched fingerprint 342 and sends the determined content files 328 to the client device 120.

In some implementations, the set of instructions 332 includes instructions to execute and/or display one or more applications on the client device 120. For example, when executed by the client device 120, the set of instructions 332 may cause the client device 120 to display an application that was minimized or running as a background process, or the set of instructions 132 may cause the client device 120 to execute the application. In some implementations, the set of instructions 332 include instructions that cause the client device 120 to download one or more content files 328 from the server system 106.

The applications 138 include one or more applications that can be executed on the client device 120. In some implementations, the applications include a media application, a feed reader application, a browser application, an advertisement application, a coupon book application and a custom application.

Each of the above identified elements may be stored in one or more of the previously mentioned memory devices, and each of the modules or programs corresponds to a set of instructions for performing a function described above. The set of instructions can be executed by one or more processors (e.g., the CPUs 302). The above identified modules or programs (i.e., trigger module 118) need not be implemented as separate software programs, procedures or modules, and thus various subsets of these modules may be combined or otherwise re-arranged in various implementations. In some implementations, memory 306 may store a subset of the modules and data structures identified above. Furthermore, memory 306 may store additional modules and data structures not described above.

Although FIG. 3A shows a rating server, FIG. 3A is intended more as functional description of the various features which may be present in a set of servers than as a structural schematic of the implementations described herein. In practice, and as recognized by those of ordinary skill in the art, items shown separately could be combined and some items could be separated. For example, some items (e.g., operating system 316 and network communication module 318) shown separately in FIG. 3A could be implemented on single servers and single items could be implemented by one or more servers. The actual number of servers used to implement the media monitoring server 130 and how features are allocated among them will vary from one implementation to another, and may depend in part on the amount of data traffic that the system must handle during peak usage periods as well as during average usage periods.

FIG. 3B is a block diagram of an example of content file data structures 328 stored in the content database 136, according to some implementations. A respective content file 328 includes meta data 346 and content 354. The meta data 346 for a respective content file 328 includes a content file identifier (file ID) 348, a content file type 250, targeted demographic 352, one or more associated fingerprints 353, metrics 355 and optionally, additional information. In some implementations, the file ID 348 uniquely identifies a respective content file 328. In other implementations, the file ID 348 uniquely identifies a respective content file 328 in a directory (e.g., a file director) or other collection of documents within the content database 136. The file type 350 identifies the type of the content file 328. For example, the file type 350 for a respective content file 328 in the content database 136 indicates that the respective content file 328 is a video file, an image file, a music file, a web page, an email message, an SMS message, a content feed, an advertisement, a coupon, a playlist and an XML document. The associated fingerprint 353 identifies one or more fingerprints in the fingerprint database 136 that are associated with the respective content file 328. In some implementations, the associated fingerprints for a respective content file are determined by a broadcaster or creator of the document. In some implementations, the associated fingerprints are extracted by a module associated with the media monitoring server 130 or a third party device/system. The targeted demographic 352 data represents the document provider's targeted demographic for the content file 328. The target demographic data represents the population of users, with particular demographic characteristics, that the document provider wishes to target with the file. The characteristics may be one or more of: age, gender, income, geographic location, education, wealth, religion, race, ethic group, marital status, household size, employment status, and political party affiliation. The target demographic data may be represented in absolute terms (e.g., “females between 18 and 25 years in age”) or, in some implementations, probabilistically (e.g., “84% male, 16% female, 5% 0-10 years old, 15% 11 to 20 years in age, 80% 20 to 45 years in age”). The metrics 355 provide a measure of the importance of a file 328. In some implementations, the metrics 355 are set by the creator or owner of the document. In some implementations, the metrics 355 represent popularity, number of views or a bid. In some implementations, multiple parties associate files with a content fingerprint and each party places a bid to have their file displayed when content corresponding to the content fingerprint is detected. In some implementations, the metrics 355 include a click through-rate. For example, a webpage may be associated with a content fingerprint.

FIG. 4A is a block diagram of a configuration of the client device 102 according to some implementations. The client device 102 typically includes one or more processing units (CPU's) 402, one or more network or other communications interfaces 408, memory 406, and one or more communication buses 404, for interconnecting these and various other components. The communication buses 404 optionally include circuitry (sometimes called a chipset) that interconnects and controls communications between system components. The client device 102 may also include a user interface comprising a display device 413 and a keyboard and/or mouse (or other pointing device) 414. Memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the CPU(s) 402. Memory 406, or alternatively the non-volatile memory device(s) within memory 406, comprises a non-transitory computer readable storage medium. In some implementations, memory 406 or the computer readable storage medium of memory 306 store the following programs, modules and data structures, or a subset thereof including operation system 416, network communication module 418, a video module 426 and data 420.

The client device 102 includes a video input/output 430 for receiving and outputting video streams. In some implementations, the video input/output 430 is configured to receive video streams from radio transmissions, satellite transmissions and cable lines. In some implementations the video input/output 430 is connected to a set top box. In some implementations, the video input/output 430 is connected to a satellite dish. In some implementations, the video input/output 430 is connected to an antenna.

In some implementations, the client device 102 includes a television tuner 432 for receiving video streams or TV signals.

The operating system 416 includes procedures for handling various basic system services and for performing hardware dependent tasks.

The network communication module 418 facilitates communication with other devices via the one or more communication network interfaces 404 (wired or wireless) and one or more communication networks, such as the Internet, other wide area networks, local area networks, metropolitan area networks, and so on.

The data 420 includes video streams 161.

The video module 426 derives content information 164 from a video stream 161. In some implementations, the content information 161 includes advertisements 324, coupons 326, a user identifier 329 or any combination thereof. The user identifier 329 identifies a user of the client device 102. For example, the user identifier 329 can be an IP address associated with a client device 102 or an alphanumeric value chosen by the user or assigned by the server that uniquely identifies the user. In some implementations, the advertisements 324 include advertisements related to goods and/or services associated with the media content the user is exposed to, based on the media exposure measurements. In some implementations, the coupons 326 include discounts related to goods and/or services associated with the media content the user is exposed to, based on the media exposure measurements. The video module 426 may generate several sets of content information 164 for a respective video stream 161.

Each of the above identified elements may be stored in one or more of the previously mentioned memory devices, and each of the modules or programs corresponds to a set of instructions for performing a function described above. The set of instructions can be executed by one or more processors (e.g., the CPUs 402). The above identified modules or programs (i.e., sets of instructions) need not be implemented as separate software programs, procedures or modules, and thus various subsets of these modules may be combined or otherwise re-arranged in various implementations. In some implementations, memory 306 may store a subset of the modules and data structures identified above. Furthermore, memory 406 may store additional modules and data structures not described above.

Although FIG. 4A shows a client device, FIG. 4A is intended more as functional description of the various features which may be present in a client device than as a structural schematic of the implementations described herein. In practice, and as recognized by those of ordinary skill in the art, items shown separately could be combined and some items could be separated.

FIG. 4B is a block diagram of a configuration of a client device 120, in accordance with some implementations. The client device 120 typically includes one or more processing units (CPU's) 121, one or more network or other communications interfaces 445, memory 122, and one or more communication buses 441, for interconnecting these and various other components. The communication buses 441 optionally include circuitry (sometimes called a chipset) that interconnects and controls communications between system components. The client device 120 may also include a user interface comprising a display device 128, speakers 129 and a keyboard and/or mouse (or other pointing device) 444. Memory 122 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 122 may optionally include one or more storage devices remotely located from the CPU(s) 121. Memory 122, or alternatively the non-volatile memory device(s) within memory 122, comprises a non-transitory computer readable storage medium. In some implementations, memory 122 or the computer readable storage medium of memory 122 store the following programs, modules and data structures, or a subset thereof including operation system 447, network communication module 448, graphics module 449, a instruction module 124 and applications 125.

The operating system 447 includes procedures for handling various basic system services and for performing hardware dependent tasks.

The network communication module 448 facilitates communication with other devices via the one or more communication network interfaces 445 (wired or wireless) and one or more communication networks, such as the Internet, other wide area networks, local area networks, metropolitan area networks, and so on.

The instruction module 124 receives a set of instructions 432 and optionally content files 428 and/or links to content files 430. The instruction module 124 executes the set of instructions 432. In some implementations, the instruction module 124 executes an application 125 in accordance with the set of instructions 432. For example, in some implementations, the instruction module 124 executes a web browser 455-1 which displays a web page in accordance with the set of instructions 432. In some implementations, the instruction module 124 displays the contents of one or more content files 428. For example, in some implementations, the instruction module 124 may display an advertisement. In some implementations, the instruction module 124 retrieves one or more content files referenced in the links 430.

The client device 120 includes one or more applications 125. In some implementations, the applications 125 include a browser application 455-1, a media application 455-2, a coupon book application 455-3, a feed reader application 455-4, an advertisement application 455-5 and custom applications 455-6. The browser application 455-1 displays web pages. The media application 455-2 plays videos and music, displays images and manages playlists 456. The feed reader application 355-4 displays content feeds 458. The coupon book application 455-3 stores and retrieves coupons 457. The advertisement application 455-5 displays advertisements. The custom applications 455-6 display information from a website in a format that is easily viewable on a mobile device. The applications 125 are not limited to the applications discussed above.

Each of the above identified elements may be stored in one or more of the previously mentioned memory devices, and each of the modules or programs corresponds to a set of instructions for performing a function described above. The set of instructions can be executed by one or more processors (e.g., the CPUs 121). The above identified modules or programs (i.e., sets of instructions) need not be implemented as separate software programs, procedures or modules, and thus various subsets of these modules may be combined or otherwise re-arranged in various implementations. In some implementations, memory 306 may store a subset of the modules and data structures identified above. Furthermore, memory 306 may store additional modules and data structures not described above.

Although FIG. 4B shows a client device, FIG. 4B is intended more as functional description of the various features which may be present in a client device than as a structural schematic of the implementations described herein. In practice, and as recognized by those of ordinary skill in the art, items shown separately could be combined and some items could be separated.

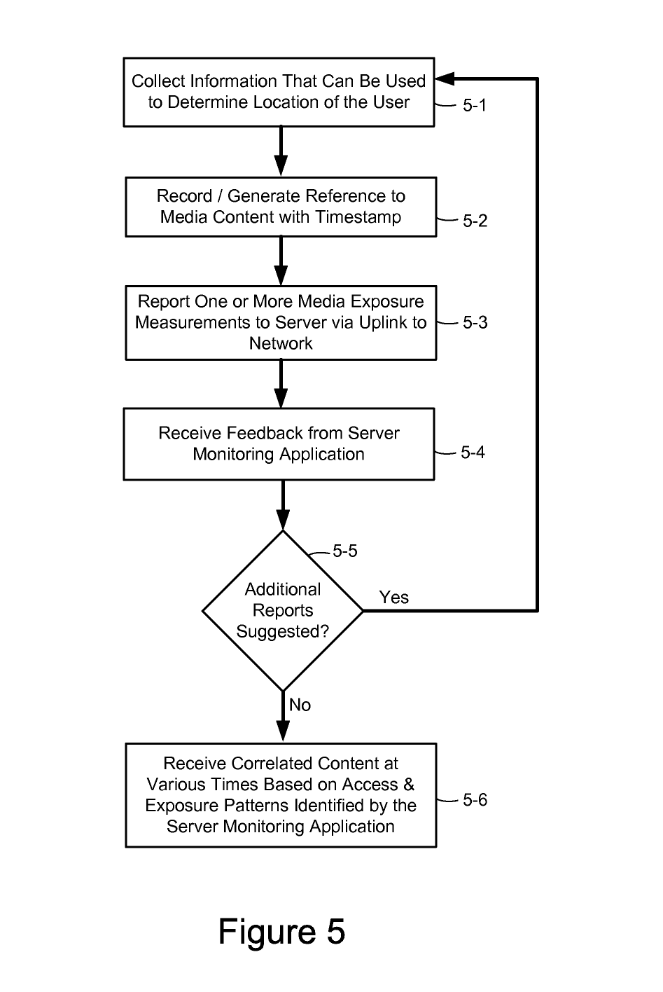

FIG. 5 is a flowchart representation of a method according to some implementations. In some implementations, the method is performed by a client device (e.g. client device 120 of FIG. 2) or a similarly configured device in order to collect and report media exposure measurements to a media monitoring server. As represented by block 5-1, the method optionally includes, at the discretion of an end user, the client device collecting information that can be used to determine the location of the client device. For example, in some implementations, the client device includes or has access to a navigation systems, such as GPS (global positioning system), that provides the client device with actual location information that the client device can link to a media exposure measurement. In another example, in some implementations, the client device collects information about one or more WiFi networks (or the like) that the client device can currently detect. The client device does not necessarily have to have access rights to such networks. Rather, in some implementations it is sufficient that the client device is merely able to detect and recognize the WiFi networks in the immediate vicinity of the client device. In turn, the client device or server system can access a lookup table to determine where the WiFi networks are likely located and based on signal strength and/or access rights and capabilities, estimate the location of the client device with respect to the location of the WiFi networks. Similarly, in some implementations the client device can collect information related to which cellular base stations or the like (e.g. femto nodes and pico nodes) are within the immediate vicinity of the client device. For example, based on training sequences or identification codes transmitted by the base stations of particular cellular wireless network operators and/or the relative power at which corresponding base station signals are received, a client device or a system server can determine by, for example, triangulation, where the client device is located and possibly how fast and in which direction the client device is travelling.

Additionally and/or alternatively, a camera on a client device (e.g. camera 124 of FIG. 1) can be used to scan barcodes, quick response (QR) codes, logos or covers so that the user can use the client device to record times when the user is reading a particular magazine, book, catalogue or the like.

Additionally and/or alternatively, the camera may be used to scan receipts in order to record purchase measurements. In some implementations, the server applies an optical character recognition technique to the image of the receipt to determine what was purchased and create a corresponding record that can be used to identify correlated content, goods/ and/or services. In some implementations, the client device performs applies an optical character recognition technique to the image of the receipt to create a record.

As represented by block 5-2, the method includes recording and/or generating a reference to media content that the client device is exposed to along with a timestamp. In other words, the client device serves a proxy for the user, assuming that the client device remains co-located with the user throughout the day. The reference to the media content allows either a client device or a server system to determine the form and content of the media content. For example, a reference to a portion of a video stream may include a time indicator and/or a digital marker referencing the content of the video stream. With further reference to FIG. 2, the content information 164 is derived from a video stream being presented (i.e. playing) by the combination of the TV 110 and the client 102. As noted above, each reference includes a timestamp so that the media exposure measurements can be analyzed according to time patterns, as well as location patterns derived from the location data.

As represented by block 5-3, the method includes the client device reporting the media exposure measurements to the server system for analysis. In some implementations, the client device reports media exposure measurements in real-time as the measurements are made. In some implementations, the client device reports a collection of media exposure measurements after a particular duration, such as, for example, after several hours, a day or a week, etc. As represented block 5-4, the method optionally includes the client device receiving feedback from a server monitoring application that has made one or more determinations based on the media exposure measurements reported by the client device.

As represented by block 5-5, the method optionally includes determining whether the server system has requested the client device to make additional reports. If the server system has suggested that the client device make additional media exposure reports (“Yes” path from block 5-5), the method includes reiterating from the portion of the method represented by block 5-1. On the other hand, if the server system has not suggested that the client device make additional media exposure measurements (“No” path from block 5-5), as represented by block 5-6, the method includes the client device receiving content correlated to the media content consumed and/or exposed to the user based on the media exposure measurements reported by the client device.

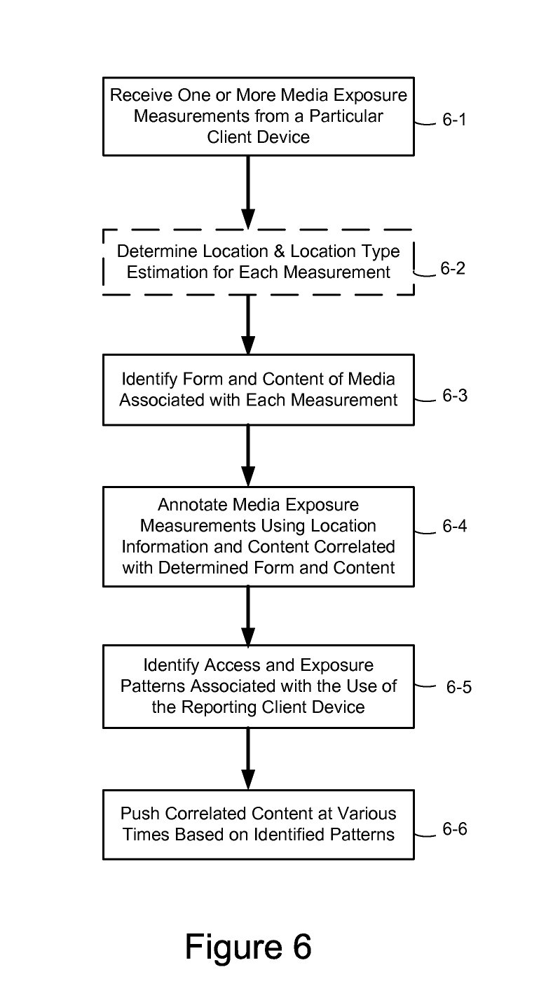

FIG. 6 is a flowchart representation of a method according to some implementations. In some implementations, the method is performed by a media monitoring server (e.g. content information extraction module 131 of FIG. 1) in order to collect and analyze media exposure measurements on an individual client device basis (e.g. client device 120 of FIG. 2). As represented by block 6-1, the method includes receiving one or more media exposure measurements from a particular client device associated with a particular user. Again, in some implementations, each client device serves as a proxy for a particular user. As such, the media exposure measurements from a particular client device can be used to determine the forms and content of media a user is exposed to or consume, and in some implementations, when the user is exposed to or consumes the media content. In some implementations, as the discretion of the user, location information can be used to determine where the user is when the user is exposed to or consumes various types of media content. To that end, as represented by block 6-2, the method optionally includes determining the location, and in some cases, the type of location associated with one or more of the media exposure measurements. As noted above, a client device may collect and/or detect various types of network data that allows the media monitoring server or another system to estimate where the client device was located when a particular media exposure measurement was taken.

As represented by block 6-3, the method includes identifying the form and content of media associated with each media exposure measurement. For example, the method includes determining the identity of the playing media content by comparing the reference to information in a fingerprint database. As represented by block 6-4, the method includes annotating each media exposure measurement with the location information (if determined) and with content correlated with the determined form and content associated with the media exposure measurement. As represented by block 6-5, the method includes identifying access and exposure patterns associated with the use of the client device based on the media exposure measurements.

Additionally and/or alternatively, the media monitoring server correlates data across media exposure measurements from a number of client devices, each serving as a proxy for a particular user. In other words, the media exposure measurements are correlated across two or more users that share similar and/or overlapping demographic information to create a profile of a particular demographic of users having similar and/or overlapping demographic information.

As represented by block 6-6, the method includes pushing correlated content at various times based on the identified patterns. For example, if based on the media exposure measurements, it is determined that a particular user regularly searches for restaurants during particular days of the week before what is customarily dinner time, advertisements or coupons for local restaurants may be pushed to the client device for the user to consider.

Additionally and/or alternatively, the media monitoring server links the patterns to demographic information associated with the reporting user or users, and identifies other users with similar and/or overlapping demographic information. Further, the media monitoring server, having identified other users with similar demographic information, pushes correlated content to some or all such users at various times based on the identified patterns based on media exposure measurements provided reporting users. In other words, the client device serves as a proxy for a reporting user, and the reporting user servers as a representative member of a group of users with similar and/or overlapping demographic information. For example, if based on the media exposure measurements, it is determined that a particular user regularly searches for restaurants during particular days of the week before what is customarily dinner time, advertisements or coupons for local restaurants may be pushed to the client devices of some or all users that share similar and/or overlapping demographic information with reporting user.

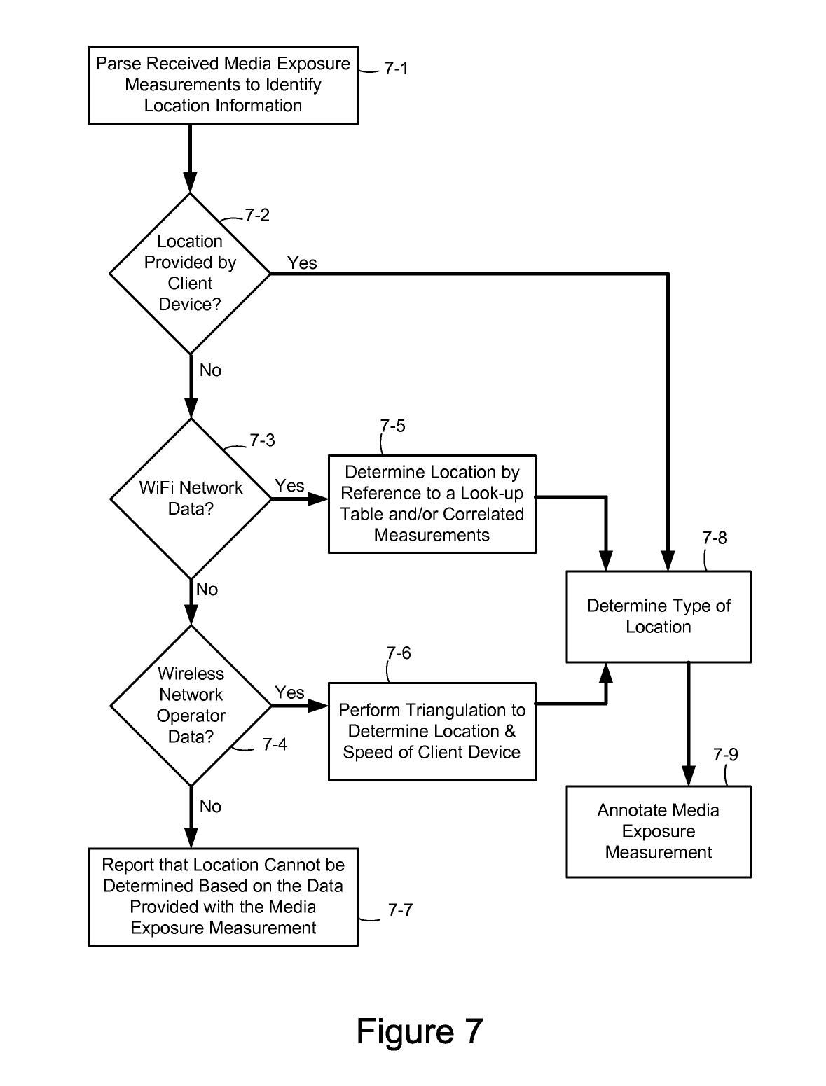

FIG. 7 is a flowchart representation of a method according to some implementations. In some implementations, the method is performed by a media monitoring server (e.g. content information extraction module 131 of FIG. 1) in order to determine a location and possibly a location type estimate associated with each of one or more media exposure measurements received from a client device. As represented by block 7-1, the method includes parsing received media exposure measurements to identify location information collected by the client device at the discretion of the user.

As represented by block 7-2, the method includes determining whether or not the client device provided an actual location, such as from a navigation system, along with the media exposure measurement. If the client device provided an actual location (“Yes” path from block 7-2), as represented by block 7-8, the method includes determining the type of location based on, for example, access to a database or online service (e.g. Google Maps). On the other hand, if the client device did not provide an actual location (“No” path from block 7-2), as represented by block 7-3, the method includes determining if the client device provided WiFi network data measurements.

If the client device provided WiFi network data measurements (“Yes” path from block 7-3), as represented by block 7-5, the method includes determining the associated location of the media exposure measurement by referencing a lookup table and/or correlated references. On the other hand, if the client device did not provide WiFi network data measurements (“No” path from block 7-3), as represented by block 7-4, the method includes determining if the client device provided wireless network operator data, such as for example, measurements of codes and/or received power from cellular base stations or the like.

If the client device provided wireless network operator data (“Yes” path from block 7-4), as represented by block 7-6, the method includes determining the associated location, and possibly the trajectory of the client device, associated with the media exposure measurement by, for example, triangulation. On the other hand, if the client device did not provide wireless network operator data (“No” path from block 7-4), as represented by block 7-5, the method includes reporting that the location cannot be determined based on the information included with the media exposure measurement.

According to the illustrated implementation, following the portion of the method represented by blocks 7-5 and 7-6, the method includes performing the portion of the method represented by block 7-8, as discussed above. Subsequently, as represented by block 7-9, the method includes annotating the media exposure measurement with the derived location information.

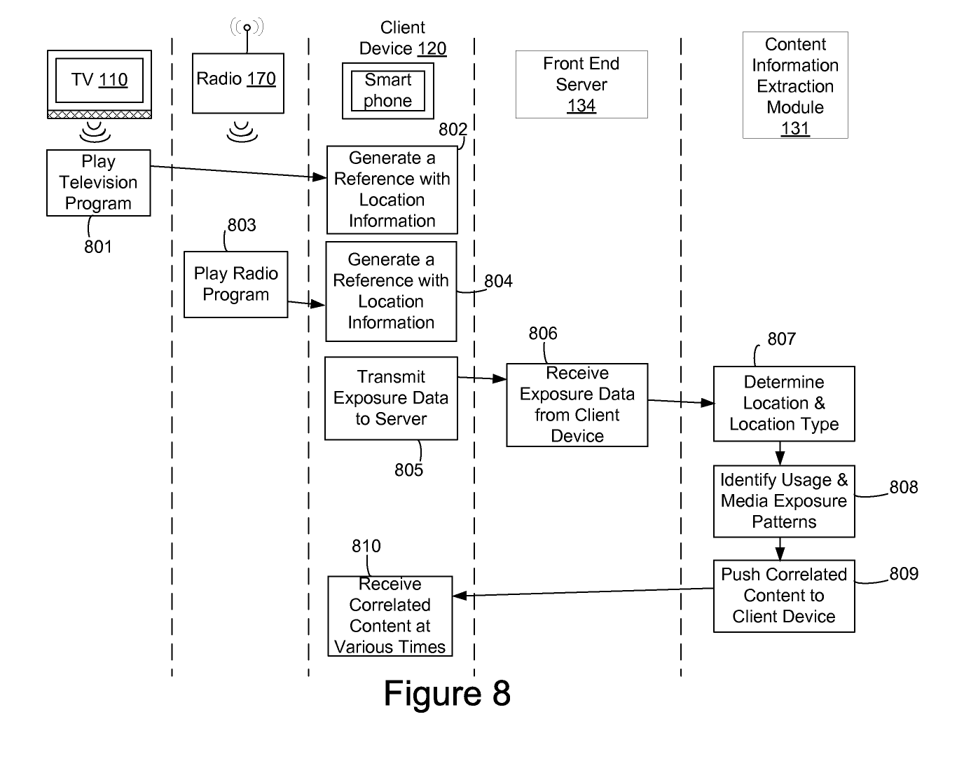

With further reference to FIGS. 1 and 2, FIG. 8 is a signaling diagram representation of some of the transmissions between components in the client-server environment 100. As represented by block 801, the TV 110 plays a television program, such as, without limitation, a drama, a political debate, the nightly news, or a sporting event. Playing a television program includes displaying video on a display and outputting audio using speakers. As represented by block 802, client device 120 generates a reference to the TV program playing on the TV 110, optionally recording location data at the discretion of the end user of the client device 120. To that end, in some implementations, the client device 120 records at least one of audio or video output by the TV 110. In some implementations, the TV 110 and client device 120 or the client device 102 and the client device 120 share a data connection that allows the client device 120 to retrieve content associated with the playing television program that can be used to generate the reference. As represented by block 803, the radio 170 plays a radio program, such as, without limitation, music or talk radio. As represented by block 804, client device 120 generates a reference to the radio program in a manner to similar to the manner in which the reference to the TV program was generated.

As represented by block 805, the client device transmits the media exposure measurement data to the server. As represented by block 806, the front end server 134 of the media monitoring server 130 receives the media exposure measurements from the client device 120. As represented by block 807, the content information extraction module 131 optionally determines the location and location type associated with one or more of the media exposure measurements. As represented by block 808, the content information extraction module 131 optionally identifies access and exposure patterns associated with the use of the client device based on the media exposure measurements. As represented by block 809, content information extraction module 131 pushes correlated content to the client device 120. As represented by block 810, the client device 120 receives correlated content at various times based on the identified usage and media exposure patterns.

The foregoing description, for purpose of explanation, has been described with reference to specific implementations. The aspects described above may be implemented in a wide variety of forms, and thus, any specific structure and/or function described herein is merely illustrative. Moreover, the illustrative discussions above are not intended to be exhaustive or to limit the methods and systems to the precise forms disclosed. Many modifications and variations are possible in view of the above teachings. The implementations were chosen and described in order to best explain the principles of the methods and systems and their practical applications, to thereby enable others skilled in the art to best utilize the various implementations with various modifications as are suited to the particular use contemplated.

Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

Moreover, in the foregoing description, numerous specific details are set forth to provide a thorough understanding of the present implementation. However, it will be apparent to one of ordinary skill in the art that the methods described herein may be practiced without these particular details. In other instances, methods, procedures, components, and networks that are well known to those of ordinary skill in the art are not described in detail to avoid obscuring aspects of the present implementation.

It will also be understood that, although the terms “first,” “second,” etc. may be used herein to describe various features, these features are not limited by these terms. These terms are only used to distinguish one element from another. For example, a first device could be termed a second device, and, similarly, a second device could be termed a first device, without changing the meaning of the description, so long as all occurrences of the “first device” are renamed consistently and all occurrences of the “second device” are renamed consistently.

Moreover, the terminology used herein is for the purpose of describing particular implementations and is not intended to be limiting of the claims. As used in the description of the implementations and the claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean ^{“}upon determining” or “in response to determining” or “in accordance with a determination” or “upon detecting” or “in response to detecting” that the stated condition precedent is true, depending on the context.

1. A method of tracking media exposure and receiving correlated content on a first mobile device including at least one processor and memory storing programs for execution by the at least one processor, the method comprising:
referencing a portion of media content;
collecting data that can be used to determine location of the first device, and linking the data to the reference;
transmitting the reference to the portion of the media content to an information extraction module;
receiving from the information extraction module one or more content elements correlated to the media content; and
displaying the one or more content elements.

2. The method of claim 1, wherein each content element includes at least one of a text segment, an image, a sound clip, and a video clip.

3. The method of claim 1, wherein referencing the portion of the media content includes recording the referenced portion of the media content from media content playing to a user of the first device.

4. The method of claim 3, wherein the recorded portion of the media content includes at least one of audio components and image components.

5. The method of claim 1, wherein the media content is playing on a second device separate from the first device.

6. The method of claim 5, wherein the second device includes at least one of a television, a computer, a video display system, a radio and an audio system.

7. The method of claim 1, wherein the media content is playing on the first device.

8. The method of claim 5, wherein the displaying is to a touch screen display of the first device, and the method further comprises enabling user interaction with the touch-screen display to allow a user to individually select a respective content element by touching a portion of the touch-screen display displaying the respective content element.

9. The method of claim 1, wherein the first device includes a mobile telephone, an Internet-connected laptop computer, or an Internet-connected tablet computer.

10. The method of claim 1, further comprising:
recording an audio soundtrack of the media content; and
sending audio content to the information extraction module derived from the recorded audio soundtrack to enable the information extraction module to determine from among a plurality of media content transmissions a particular media program by matching the received audio content to audio soundtracks of the media content transmissions.

11. A non-transitory computer readable storage medium storing one or more programs configured for execution by a first mobile device with one or more processors, the one or more programs comprising computer program instructions that when executed by the one or more processors cause the first device to:
reference a portion of media content;
collect data that can be used to determine location of the first device, and linking the data to the reference;
transmit the reference to the portion of the media content to an information extraction module;
receive from the information extraction module one or more content elements correlated to the media content; and
display the one or more content elements.

12. (canceled)

13. The computer readable storage medium of claim 11, wherein referencing the portion of the media content includes recording the referenced portion of the media content from media content playing to a user of the first device.

14. The computer readable storage medium of claim 13, wherein the recorded portion of the media content includes at least one of audio components and image components.

15. The computer readable storage medium of claim 11, wherein the media content is playing on a second device separate from the first device.

16-19. (canceled)

20. The computer readable storage medium of claim 11, wherein the computer program instructions further comprise instructions that when executed by the processor cause the first device to:
record an audio soundtrack of the media content; and
send audio content to the information extraction module derived from the recorded audio soundtrack to enable the information extraction module to determine from among a plurality of media content transmissions a particular media program by matching the received audio content to audio soundtracks of the media content transmissions.

21. A system for tracking media exposure and receiving correlated content comprising:
a first mobile device having one or more processors and non-transitory memory storing computer program instructions for execution by the one or more processors, upon execution the computer program instructions causing the first device to:
reference a portion of media content;
collect data that can be used to determine location of the first device, and linking the data to the reference;
transmit the reference to the portion of the media content to an information extraction module;
receive from the information extraction module one or more content elements correlated to the media content; and
display the one or more content elements.

22. (canceled)

23. The system of claim 21, further comprising one or more media content recorders, wherein the reference to the portion of the media content includes a recording of the referenced portion of the media content from media content playing to a user of the first device captured by the media content recorders.

24. The system of claim 23, wherein the recorded portion of the media content includes at least one of audio components and image components.

25. The system of claim 21, wherein the media content is playing on a second device separate from the first device.

26-29. (canceled)

30. The system of claim 21, wherein the computer program instructions further comprise instructions that when executed by the processor cause the first device to:
record an audio soundtrack of the media content; and
send audio content to the information extraction module derived from the recorded audio soundtrack to enable the information extraction module to determine from among a plurality of media content transmissions a particular media program by matching the received audio content to audio soundtracks of the media content transmissions.
